(19) United States
(12) Patent Application Publication
(10) Pub. No.: US 2008/0194147 A1
(43) Pub. Date: Aug. 14, 2008

(54) Connector

(75) Inventors: Chin-Tse WU, Taoyuan Hsien (TW); Chen-Jung CHEN, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS INC.

(21) Appl. No.: 11/987,238

(22) Filed: Nov. 28, 2007

(30) Foreign Application Priority Data
Feb. 12, 2007 (TW) 96202628

(51) Int. Cl. H01R 13/66

(52) U.S. Cl. 439/620.21

(57) ABSTRACT

A connector includes a main body for receiving a RJ-45 plug and a fixer disposed in the main body. The fixer includes at least one barricade for blocking the movement of a non-RJ-45 plug and at least one supported part connected to the barricade. The barricade and the supported part are made of different materials.

### BACKGROUND OF THE INVENTION

This Non-provisional application claims priority under U.S.C. § 119(a) on Patent Application No(s). 096202628, filed in Taiwan, Republic of China on Feb. 12, 2007, the entire contents of which are hereby incorporated by reference.

### FIELD OF THE INVENTION

The invention relates to a connector, and more particularly to a foolproof connector suitable for accommodating an RJ-45 plug.

### DESCRIPTION OF THE RELATED ART

With the progress of the communication technologies, electronics and communication products such as computers and peripherals have proliferated. Different data and information can be conveniently retrieved from networks, thus improving quality of life.

Nowadays, Internet is constantly and rapidly developed, and kinds of communication skills applied on the Internet are correspondingly appeared. A conventional concentrated computer system provided with few sets of PCs or related equipment is no longer used, instead of the PCs and the related equipment distributed at different places for providing services such as data processing and consulting affairs. Basically, desktops, laptops and palms are provided with interfaces for connecting Internet. RJ-45 plugs, for example, are popularly employed in network systems for coupling to different connectors. Referring to FIGS. 1A and 1B, FIG. 1A is a schematic view of an inner structure of a conventional connector 1, and FIG. 1B is a sectional view of a RJ-45 plug 14 connected to the connector 1 of FIG. 1. In order to prevent unwanted or incompatible plugs from entering the connector 1, the metallic reed 12 of the connector 1 is provided with recesses 121a and 121b. When a non-RJ-45 plug, such as an RJ-11 plug, is inserted into the connector 1, the recesses 121a and 121b block the movement of the RJ-11 plug so as to prevent the RJ-11 plug from entering the body 11 of the connector 1 and connecting with terminals 13, and thus the foolproof effect is achieved.

However, considering of the connector 1 being capable of foolproof, angles and elasticity factors must be carefully considered when designing and manufacturing the metallic reed 12. Also, once a non-RJ-45 plug is forced by users, the non-RJ-45 plug is still be able to enter the connector 1, and thus the foolproof function of the connector 1 fails. In addition, the hardness of the metallic reed 12 is high so as to cause the plugs made of lower hardness materials to be scratched or damaged.

### BRIEF SUMMARY OF THE INVENTION

The present invention provides a foolproof connector with a large blocking area, to prevent failure of the foolproof function caused by an abnormal acting force, meritoriously characterized by metallic elasticity and polymeric absorption due to use of metallic and polymeric materials, thus, preventing the plug from being scratched or damaged.

An embodiment of a foolproof connector of the present invention includes a main body for receiving a predetermined plug and a fixer disposed in the main body. The fixer includes at least one barricade and at least one supported part. The barricade blocks the movement of an incompatible plug. The supported part is connected to the barricade. The barricade and the supported part are made of different materials.

The barricade includes a slanted surface, a recessed portion and an extended portion. The slanted surface, the recessed portion and the extended portion are integrally formed as a single piece. The recessed portion disposed on the slanted surface blocks the movement of the incompatible plug. The slanted surface is used to guide the predetermined plug into the main body. The barricade is made of a polymeric material formed by injection molding. The supported part is a hook-like metallic piece having a hook-like end connected to the extended portion of the barricade. The hook-like end of the supported part is connected to the extended portion of the barricade by embedding, clamping, adhering, contacting or other connecting methods. The main body includes a plurality of terminals electrically connected to the predetermined plug. The main body includes at least one latch for securing the predetermined plug such as an RJ-45 or USB plug.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a schematic view of an inner structure of a conventional connector suitable for a RJ-45 plug;

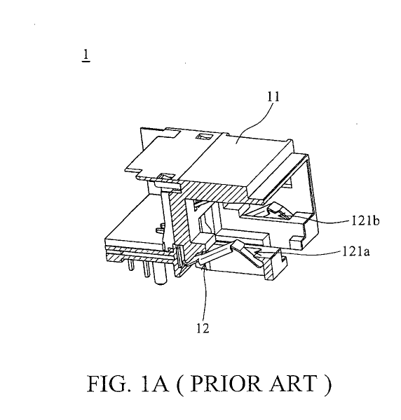

FIG. 1B is a sectional view of the RJ-45 plug connected to the connector of FIG. 1A;

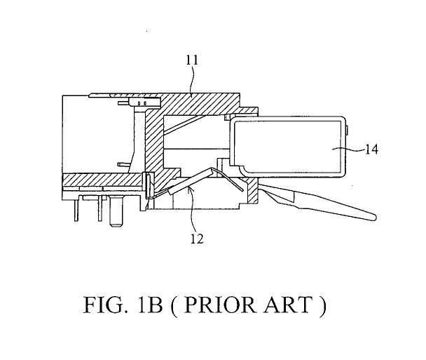

FIG. 2A is a schematic view of an inner structure of a connector according to the preferred embodiment of the present invention;

FIG. 2B is a schematic view of the connector of FIG. 2A;

FIG. 2C is a schematic view of a fixer of the connector of FIG. 2A;

FIG. 3 is a sectional view of the RJ-45 plug connected to the connector of FIG. 2A; and

FIG. 4 is a schematic view of a modified fixer of the connector of FIG. 2A.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

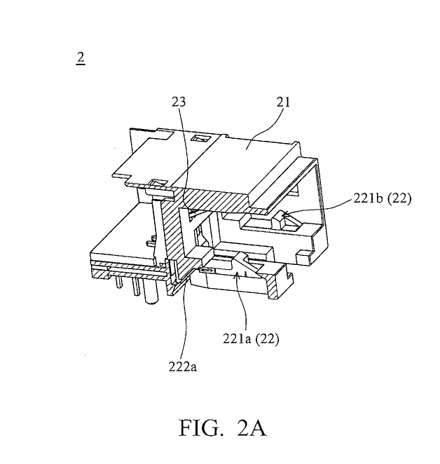

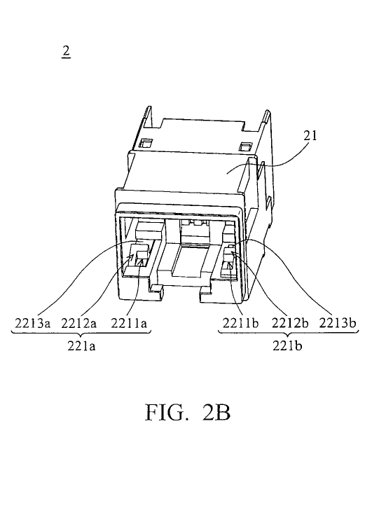

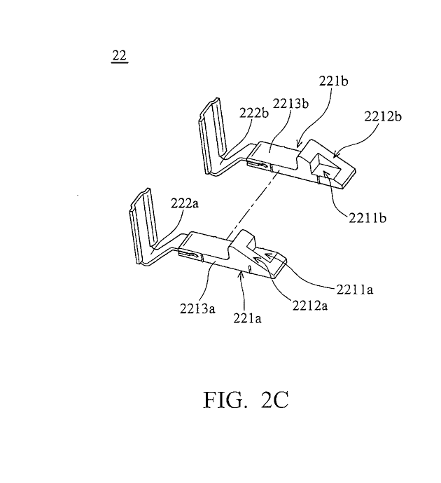

Referring to FIGS. 2A and 2B, FIG. 2A is a schematic view of an inner structure of a foolproof connector 2 according to the preferred embodiment of the present invention, and FIG. 2B is a schematic view of the foolproof connector 2 of FIG. 2A. The foolproof connector 2 includes a main body 21 having at least one latch (not shown) and a fixer 22. The main body 21 is for receiving a predetermined plug such as an RJ-45 plug. The fixer 22 disposed in the main body 21 includes at least one barricade 221a and 221b and at least one supported part 222a and 222b. In this embodiment, the quantity of the barricades 221a and 221b is two, and the quantity of the supported parts 222a and 222b is two, but the quantities of the barricades and the supported parts are not limited thereto. The barricades 221a and 221b and the supported parts 222a and 222b are made of different materials.

FIG. 2C is a schematic view of a fixer 22 of the connector of FIG. 2A. The fixer 22 includes a first barricade 221a, a second barricade 221b, a first supported part 222a and a second supported part 222b. The first barricade 221a includes a first recessed portion 2211a, a first slanted surface 2212a and a first extended portion 2213a. The first recessed portion 2211a, the first slanted surface 2212a and the first extended portion 2213a are integrally formed as a single piece. The second barricade 221b includes a second recessed portion 2211b, a second slanted surface 2212b and a second extended portion 2213b. The second recessed portion 2211b, the second slanted surface 2212b and the second extended portion 2213b are integrally formed as a single piece.

The first recessed portion 2211a disposed on the first slanted surface 2212a and the second recessed portion 2211b disposed on the second slanted surface 2212b serve to block the movement of incompatible plugs, such as RJ-11, USB plugs, and so on. The RJ-45 plug is guided into the main body 21 by the first slanted surface 2212a of the first barricade 221a and the second slanted surface 2212b of the second barricade 221b.

The first and second barricades 221a and 221b are made of a polymeric material. The first and second supported parts 222a and 222b are hook-like metallic pieces provided with reed elastic force and capable of being made by different material. Note that the first and second barricades 221a and 221b made of a polymeric material can prevent form the scratching of the RJ-45 plug. The hook-like end of each of the first and second supported parts 222a and 222b is connected to the extended portion 2213a and 2213b of the first and second barricades 221a and 221b by embedding, clamping, adhering, contacting or other connection method, thereby forming the fixer 22.

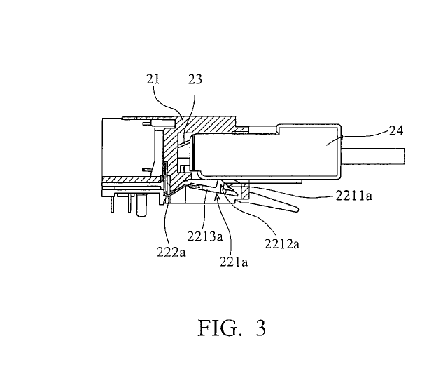

FIG. 3 is a sectional view of the RJ-45 plug 24 connected to the connector 2 of FIG. 2A. When the RJ-45 plug 24 is inserted into the connector 2, the RJ-45 plug 24 is guided into the main body 21 by moving along the first and second slanted surfaces 2212a and 2212b. Because the width of the RJ-45 plug 24 is greater than the width of the first and second recessed portions 2211a and 2211b, the RJ-45 plug 24 is not stuck by the first and second recessed portions 2211a and 2211b when the RJ-45 plug 24 is moved along the first and second slanted surfaces 2212a and 2212b. Thus, when the RJ-45 plug 24 is inserted into the main body 21 by moving along the first and second recessed portions 2211a and 2211b, the RJ-45 plug 24 is smoothly connected to the terminals 23. When the RJ-45 plug 24 and the terminals 23 are contacted, a downward force exerted by the terminals 23 deform the first and second supported parts 222a and 222b. Thus, the RJ-45 plug 24 in the main body 21 is appropriately positioned and locked by the latch of the main body 21.

When the incompatible plug such as the RJ-11 plug is inserted into the connector 2, the RJ-11 plug is prevented from contacting the first and second slanted surfaces 2212a and 2212b and may be stuck by the first and second recessed portions 2211a and 2211b because the width of the RJ-11 plug is smaller than the width of the first and second recessed portions 2211a and 2211b. Even if the RJ-11 plug is erratically or abnormally moved, the movement of the RJ-11 plug is stopped by the first and second recessed portions 2211a and 2211b, i.e., the RJ-11 plug cannot be further moved into the connector 2. Thus, due to the large blocking area provided by the fixer 22, the unwanted or incompatible plugs are prevented from connecting to terminals 23.

Because the metallic first and second supported parts 222a and 222b and the polymeric first and second barricades 221a and 221b, the foolproof connector 2 exhibits the merits of metallic elasticity and polymeric absorption. That is, the hook-like first and second supported parts 222a and 222b exhibit the merits of metallic elasticity, and the polymeric barricades 221a and 221b provided with large blocking area exhibits the merits of absorption and low material cost. Thus, the manufacturing process can be simplified without regard for factors such as angles and elasticity, and costs can be reduced.

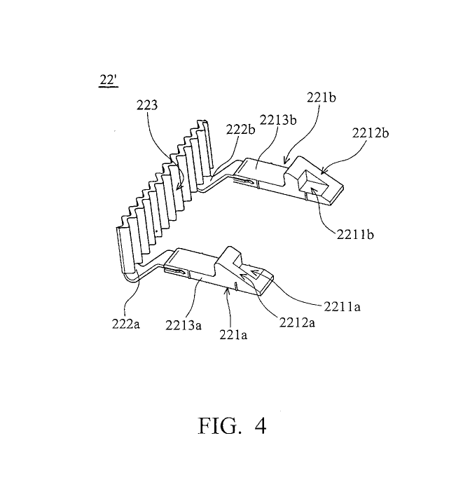

FIG. 4 is a schematic view of a modified fixer 22′ of the connector of FIG. 2A. The fixer 22′ differs from the fixer 22 in that a connecting portion 223 is further provided between the first and second supported parts. The connecting portion 223 and the first and second supported parts are integrally formed as a single piece and capable of providing metallic elasticity.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A foolproof connector, comprising:
a main body for receiving a predetermined plug; and
a fixer disposed in the main body and the fixer comprising:
at least one barricade used in blocking a movement of an incompatible plug; and
at least one supported part connected to the barricade, wherein the barricade and the supported part are made of different materials.

2. The foolproof connector as claimed in claim 1, wherein the barricade comprises a slanted surface, a recessed portion and an extended portion, and the slanted surface, the recessed portion and the extended portion are integrally formed as a single piece.

3. The foolproof connector as claimed in claim 2, wherein the recessed portion is disposed on the slanted surface, and the recessed portion is used in blocking the movement of the incompatible plug.

4. The foolproof connector as claimed in claim 2, wherein the recessed portion is disposed on the slanted surface, and the slanted surface is used to guide the predetermined plug into the main body.

5. The foolproof connector as claimed in claim 2, wherein the supported part comprises a hook-like end connected to the extended portion of the barricade.

6. The foolproof connector as claimed in claim 5, wherein the hook-like end of the supported part is connected to the extended portion of the barricade by embedding, clamping, adhering, contacting or other connecting methods.

7. The foolproof connector as claimed in claim 1, wherein the barricade comprises a polymeric material, and the barricade is formed by injection molding.

8. The foolproof connector as claimed in claim 1, wherein the main body comprises a plurality of terminals, and the terminals are electrically connected to the predetermined plug.

9. The foolproof connector as claimed in claim 1, wherein the main body comprises at least one latch for securing the predetermined plug.

10. A connector suitable for a RJ-45 plug, comprising:
a main body for receiving the RJ-45 plug; and
a fixer disposed in the main body, and the fixer comprising:
at least one barricade used in blocking a movement of a non-RJ-45 plug; and
at least one supported part connected to the barricade, wherein the barricade and the supported part are made of different materials.

11. The connector as claimed in claim 10, wherein the barricade comprises a slanted surface, a recessed portion and an extended portion, and the slanted surface, the recessed portion and the extended portion are integrally formed as a single piece.

12. The connector as claimed in claim 11, wherein the recessed portion is disposed on the slanted surface, and the slanted surface is used to guide the RJ-45 plug into the main body.

13. The connector as claimed in claim 11, wherein the recessed portion is used in blocking the movement of the non-RJ-45 plug, such as a RJ-11 plug, a USB plug, and so on.

14. The connector as claimed in claim 10, wherein the barricade comprises a polymeric material.

15. The connector as claimed in claim 14, wherein the barricade is formed by injection molding.

16. The connector as claimed in claim 11, wherein the supported part comprises a hook-like end connected to the extended portion of the barricade.

17. The connector as claimed in claim 16, wherein the hook-like end of the supported part is connected to the extended portion of the barricade by embedding, clamping, adhering, contacting or other connecting methods.

18. The connector as claimed in claim 10, wherein the supported part is a hook-like metallic piece.

19. The connector as claimed in claim 10, wherein the main body comprises a plurality of terminals, and the terminals are electrically connected to the RJ-45 plug.

20. The connector as claimed in claim 10, wherein the main body comprises at least one latch for securing the RJ-45 plug.
